(19) United States
(12) Patent Application Publication
(10) Pub. No.: US 2013/0226990 A1
(43) Pub. Date: Aug. 29, 2013

(54) INFORMATION PROCESSING SYSTEM AND INFORMATION PROCESSING DEVICE

(71) Applicants: Wataru Yamazaki, Tokyo (JP); Atsushi Matsumoto, Tokyo (JP); Takuji Morimoto, Tokyo (JP)

(72) Inventors: Wataru Yamazaki, Tokyo (JP); Atsushi Matsumoto, Tokyo (JP); Takuji Morimoto, Tokyo (JP)

(73) Assignee: MITSUBISHI ELECTRIC CORPORATION, Tokyo (JP)

(21) Appl. No.: 13/884,000

(22) PCT Filed: Jan. 18, 2011
(86) PCT No.: PCT/JP2011/000225

§ 371 Date: May 8, 2013

(51) Int. Cl. H04L 29/08

(52) U.S. Cl. CPC H04L 67/18
USPC 709/202

(57) ABSTRACT

There is provided: a user input unit 20 for receiving an input of a subject of interest at a moved point; a position detection unit 21a for detecting positional information; a user information detection unit 21 for generating interest information that contains a subject of interest inputted in the unit 20, and the positional information of a point where the corresponding subject of interest is inputted; a communications unit 23, transmissibly connected to a server device 3, for storing in the device 3 the interest information generated by the unit 21 and for acquiring the interest information retrieved in response to a request from among the interest information stored in the device 3; and an output unit 24 for outputting the interest information generated by the unit 21 or interest information acquired by the communications unit 23 to present the resultant to a user.

### TECHNICAL FIELD

The present invention relates to an information processing system capable of registering and/or presenting information related to a passing point during movement, and an information processing device using the same.

### BACKGROUND ART

As a prior art for registering information in response to an explicit operation of a user, there is a system disclosed in Patent Document 1, for example. In this system, when a user operates a remote controller, an environmental change detection means provided in the remote controller detects the operation as a change in environment around the remote controller. When the change in environment around the remote controller is detected by the environmental change detection means, this detection triggers an image pickup device to start capturing an image, so that the captured image is recorded in a recording device. In this manner, an action taken by the user around the remote controller can be recorded as a life log in response to the explicit operation of the user.

### PRIOR ART DOCUMENTS

### Patent Documents

Patent Document 1: Japanese Patent Application Laid-open No. 2008-160612

### SUMMARY OF THE INVENTION

### Problems to be Solved by the Invention

In a conventional car navigation system, there is the one such that when a specific point is registered in advance, the point can be set afterward as a destination or stopover. However, information related to a point such as facility information (POI (Point Of Interest) information) includes only the information preset at the time of shipment of the system. Thus, even when a user takes an interest in some subject at a certain point during driving by a vehicle, no information can be acquired if information related to the point is absent in the preset information.

Meanwhile, in recent years, information retrieval byway of a communications network has been popular; however, an enormous amount of information may be subjected to the retrieval depending on a retrieval key. For example, in a case where a scenic place is passed during an movement by a vehicle and a user wishes to make use of POI information related to the place, if the name of the place is used as a retrieval key, all the information including the name is subjected to the retrieval, so that a large amount of information thereof is extracted notwithstanding the information irrelevant to the place. In particular, when a large amount of information are extracted based on the retrieval carried out by the user during the movement, it is very difficult to acquire immediately information related to a desired point from these pieces of information.

In this respect, if information related to points where the user passes during the movement is retrieved from a life log such that actions of the user have been recorded anytime, information irrelevant to the corresponding point can be excluded; however, a large capacity memory device is necessary for recording the life log anytime. In addition, when the life log having been recorded anytime reaches an enormous amount thereof, it takes a retrieval time that is required to locate the information related to the desired point, which is not unrealistic as a retrieval to be performed during the movement.

In this instance, like the conventional art represented in Patent Document 1, when some explicit operation by the user triggers to record the life log, an enlargement of the life log is suppressed.

However, according to Patent Document 1, the operation of the remote controller or the change of the circumstances is merely used as a trigger for starting the recording of the information; thus, it is not possible to accurately store the subject interested by the user at the passing point during the movement.

The present invention has been made to solve the aforementioned problems, and an object of the invention is to provide an information processing system that can accurately store a subject interested by a user at a passing point during a movement, and makes it possible to use information of the point appropriately, and an information processing device using the same.

### Means for Solving the Problem

An information processing device according to the invention is installed in or carried by a moving object, and includes: a user input unit for receiving an input of a subject of interest at a point in which the moving object is moved; a position detection unit for detecting positional information of the moving object; an interest information generation unit for generating interest information that contains the subject of interest inputted in the user input unit, and the positional information of the point in which the corresponding subject of interest is inputted, and which is detected by the position detection unit; a communications unit, transmissibly connected to an external device, for storing in the external device the interest information generated by the interest information generation unit and for acquiring the interest information retrieved in response to a request from among the interest information stored in the external device; and an output unit for outputting the interest information generated by the interest information generation unit or the interest information acquired by the communications unit to present the resultant to a user.

### Effect of the Invention

According to the invention, there are effects such that the subject interested by the user can be accurately stored at a passing point during a movement, and that the information of the point can be used appropriately.

### BRIEF DESCRIPTION OF THE DRAWINGS

FIG. 1 is a block diagram showing a configuration of an information processing system according to Embodiment 1 of the present invention.

FIG. 2 is a flowchart showing a flow of processing by the information processing system of Embodiment 1.

FIG. 3 is a diagram showing an example of a screen for interested subject inputs.

FIG. 4 is a block diagram showing a configuration of an information processing system according to Embodiment 2 of the invention.

FIG. 5 is a flowchart showing a flow of edit processing by the information processing system according to Embodiment 2.

FIG. 6 is a block diagram showing a configuration of a user terminal device according to Embodiment 3 of the invention.

FIG. 7 is a flowchart showing a flow of processing by the user terminal device of Embodiment 3.

### BEST MODE FOR CARRYING OUT THE INVENTION

In the following, in order to explain the present invention in more detail, embodiments for carrying out the invention will be described with reference to the accompanying drawings.

### Embodiment 1

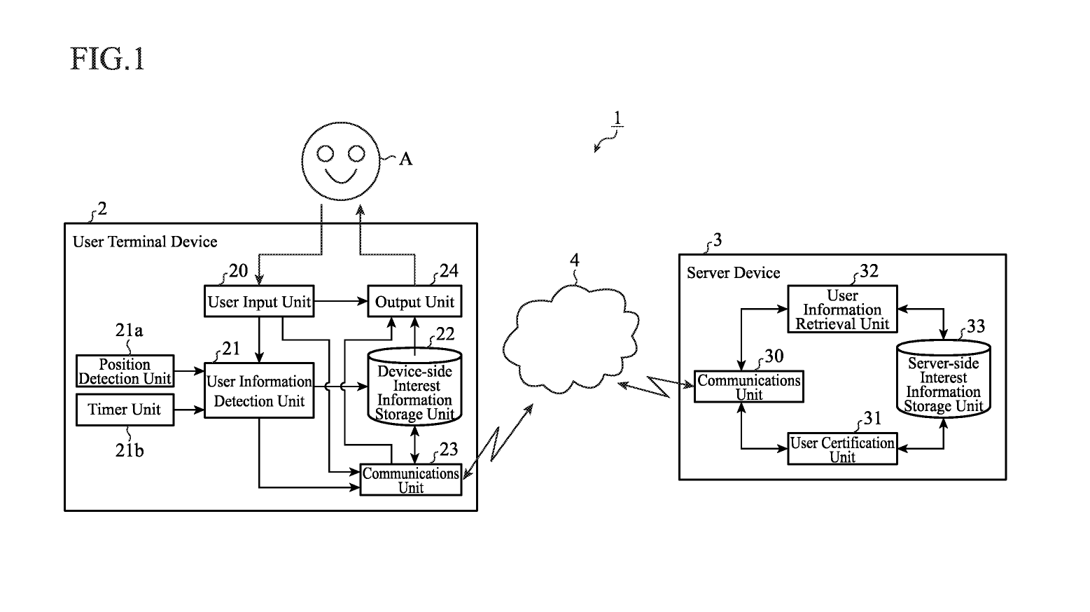

FIG. 1 is a block diagram showing a configuration of an information processing system according to Embodiment 1 of the invention. In FIG. 1, an information processing system 1 of Embodiment 1 includes a user terminal device 2 controlled by a user A and a server device 3.

The user terminal device 2 is an information processing device configured as an on-board device installed in a moving object such as a vehicle or a device carried by the user A, and can store in the server device 3 information containing a subject interested by the user A at a passing point during a movement by a vehicle or the like or during walking through a communications network 4, and can browse desired information from the information stored in the server device 3. One example of the configuration includes a user input unit 20, a user information detection unit 21, a position detection unit 21a, a timer unit 21b, a device-side interest information storage unit 22, a communications unit 23, and an output unit 24.

The user input unit 20 is a component for inputting information into the user terminal device 2, in particular, being used in a case where information to be stored in the server device 3 is inputted or a key information for retrieving information related to a point interested by the user is inputted. Since these input processes are mostly performed while the user A is moving due to the movement by the vehicle or the like or by walking, they are linked to a simple operation using the user input unit 20.

Namely, the user terminal device 2 of the invention provides a human-machine interface (HMI) for inputting the subject interested by the user A (hereinafter, referred to as an “interested subject”) at the passing point during the movement, i.e., for interested subject inputs.

For example, when the user input unit 20 is a touch panel using a display screen of the output unit 24, a display screen for interested subject inputs is displayed on the display screen as the HMI for inputting the interested subject through a touch operation. In the display screen for interested subject inputs, a software button is provided for each information category (genre), and when the user A depresses the button of the information category corresponding to the interested subject, the content of the information category is inputted as the interested subject.

Meanwhile, when the user input unit 20 is a speech recognition system, it is possible to provide the HMI for interested subject inputs to input the interested subject through a voice input operation. In this HMI, when the user A utters the interested subject, a speech recognizing result for this utterance is inputted as the interested subject. Additionally, as a configuration recording simply the utterance of the user A, the HMI for interested subject inputs may be configured such that the interested subject is inputted by recorded data.

Further, when the user input unit 20 is an image recognition system, it is possible to provide the HMI for interested subject inputs to input the interested subject through an image pickup operation. In this HMI, when the subject interested by the user A is expressed by gesture or a target of the subject is viewed, a moving picture in which the subject is taken by an image pickup device such as a camera is image recognized or gaze recognized, and the resultant is inputted as the interested subject. Incidentally, it does not matter that the taken image data is to be simply inputted as the interested subject.

The user information detection unit 21 is a component for detecting the interested subject inputted by the user A from among information inputted in the user terminal device 2 through the use of the user input unit 20. For example, information inputted through the aforementioned HMI for interested subject inputs is detected as the interested subject. That is, it is distinguished from another information, for example, in such a manner that a specific extension to the interested subject is set in the HMI for interested subject inputs.

Also, the user information detection unit 21 functions as an interest information generation unit that serially inputs positional information detected by the position detection unit 21a and time information timed by the timer unit 21b, to thereby generate interest information obtained by adding to the interested subject positional information of the point where the interested subject is inputted by the user A, a time when the interested subject is inputted, a user name, a vehicle type and the like which are extracted from preset user information.

It is noted that since the above interest information is handled as POI information related to the point where the interested subject is inputted, the additional information to the interested subject contains at least positional information of the point where the interested subject is inputted.

As mentioned above, the interested subject includes a taken image of the target of the subject interested by the user, a view position of the user viewing the target of the subject and a holding time thereof, and/or speech information.

Meanwhile, depending on the HMI for interested subject inputs, a standardized information category may be inputted as the interested subject. For example, an information category of “New Chinese Restaurant” is handled in common among multiple users. The interested subject thus handled in common among the multiple users can be used as key information for retrieving interest information related to the interested subject, and it is effective when statistical processing like classification or use frequency of the interest information is implemented.

In contrast, in a case where the interested subject is represented by information not handled in common among the multiple users, for example, a sound file of contents uniquely uttered by the user, it is effective when interest information that reflects a personality of the user is generated.

Also, the interest information is constituted by a string of information (attributions) containing the interested subject and positional information of the corresponding point. For example, it is constituted as <time, latitude, longitude, interested subject>, where the “time” is the time when the interested subject is inputted, and “latitude, longitude” each are the positional information at the point where the interested subject is inputted. Incidentally, the interest information may be constituted by a partially nested portion of information as <time, <latitude, longitude>, interested subject>.

Meanwhile, when key information for retrieving the interest information related to the point interested by the user A is inputted, the HMI simpler than the input of the interested subject may be provided.

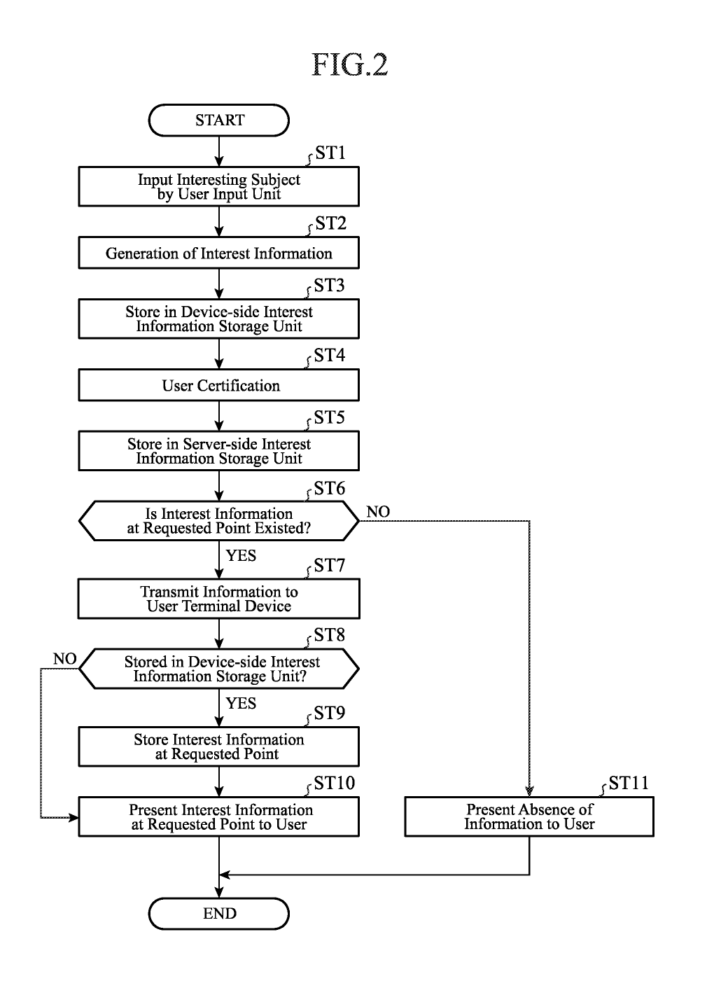

For example, when the user input unit 20 is the touch panel using the display screen of the output unit 24, a software button for point inputs is displayed on the display screen as the HMI for inputting the key information through the touch operation. When the user A passes by a scenic point and takes an interest in this point, only the depression of the button for point inputs causes the interest information related to the point (POI information) to be fed back from the server device 3 as described later in FIG. 2.

The position detection unit 21a is a component for detecting the position of the user terminal device 2, and detects current positional information by, for example, a GPS (Global Positioning System) receiver, a vehicle speed sensor, an acceleration sensor, an angular velocity sensor, and so on. The timer unit 21b is an internal clock built in a computer that functions as the user terminal device 2.

The device-side interest information storage unit 22 is a storage for storing the interest information in the user terminal device 2, and stores the interest information generated by the user information detection unit 21 and/or the interest information acquired from the server device 3 by the communications unit 23.

The communications unit 23 is a component for performing data communication by transmissibly connecting to a communications unit 30 in the server device 3 via the communications network 4 such as the Internet.

The output unit 24 is a component for outputting and presenting the interest information to the user A, and functions as at least a display output unit for displaying the interest information on a display monitor and an audio output unit for audio-outputting the interest information through a speaker or the like.

It is noted that the user input unit 20, the user information detection unit 21, the position detection unit 21a, the timer unit 21b, the communications unit 23, and the output unit 24 are implemented as a specific means by incorporation of hardware and software, for example, when an information processing program according to the purpose of the present invention is executed by a computer serving as the user terminal device 2.

Further, the device-side interest information storage unit 22 is established on, for example, a memory region of a memory device mounted in the aforementioned computer. For the memory device, a hard disk device, a semiconductor memory, and a drive device for memory media of a CD, a DVD and so on are specified.

The server device 3 is an information retrieval server for managing the interest information for every user, and for retrieving and returning the interest information requested by the user, and is transmissibly connected to the user terminal device via the communications network 4. One example of the configuration includes the communications unit 30, a user certification unit 31, a user information retrieval unit 32 and a server-side interest information storage unit 33.

The communications unit 30 is a component for performing data communication by transmissibly connecting to a communications unit 23 in the user terminal device 2 via the communications network 4.

The user certification unit 31 is a component for performing certification processing for the user that desires to store and browse (or edit) the interest information. For example, the user certification unit 31 manages user IDs given to the users registered for services provided by the information processing system 1, and performs the user certification by checking the user IDs included in a variety of requests from the user terminal device 2.

The user information retrieval unit 32 is a component for retrieving the interest information requested by the user terminal device 2 from the server-side interest information storage unit 33, and, for example, performs the retrieval by using the interested subject and the additional information contained in the interest information as the key. Further, it may be given therein a retrieval function for executing a calculation based on the retrieval result, for example, a calculation of a frequency in which the same information (attributions) is used and/or a change in a given time period of this frequency.

It is noted that when a retrieval of the interest information using positional information of the point (latitude, longitude) as the key is requested, the user information retrieval unit 32 retrieves the interest information related to the points included within an area in a predetermined range that includes the point of the retrieval key. For example, the interest information of the points within a circular area of which the radius centering around the point is a predetermined distance is determined as a subject to be retrieved.

The above predetermined range has only to be within a distance in which the user is expected to have the same kind of interest as that at the point of the retrieval key, and is considered an area in which a difference of distance with the position of the point of the retrieval key is the degree of 30 meter.

Further, when a retrieval of the interest information in which the time is included in the key is requested, a retrieval is also made for the interest information corresponding to a drifted time from that time in a predetermined range of time. The above predetermined range of time also has only to be such a range of time that the user is expected to have the same kind of interest as that at the time of the retrieval key, and is considered a range of time around 30 minutes in a difference of time with the time of the retrieval key.

The server-side interest information storage unit 33 is a storage for storing interest information transmitted from the user terminal device 2, and the interest information is stored associated with an ID of the user as a generator. It is noted that interest information stored in the server-side interest information storage unit 33 is constituted by a string of information (attributions) containing the interested subject and positional information of the corresponding point, similarly to the case of the device-side interest information storage unit 22.

It is noted that the communications unit 30, the user certification unit 31, and the user information retrieval unit 32 are implemented as a specific means by incorporation of hardware and software, for example, when the information processing program according to the purpose of the present invention is executed by a computer serving as the server device 3. Further, the serve-side interest information storage unit 33 is established on, for example, the memory region of the memory device mounted in the aforementioned computer.

Next, an operation thereof will be described.

FIG. 2 is a flowchart showing a flow of processing by the information processing system according to Embodiment 1, and a description will be given of a case where the user terminal device 2 is configured as an on-board device.

It is noted that the processing by the information processing system 1 of Embodiment 1 is divided into a process for inputting the interested subject through an explicit operation performed by the user and generating interest information containing the interested subject to store the resultant in the serve device 3, and a process for browsing (using) interest information related to the point where the user passes by during the movement.

1) Production and Store of Interest Information

The subject interested by the user A (interested subject) at the passing point during the movement is inputted by the user input unit 20 (Step ST1).

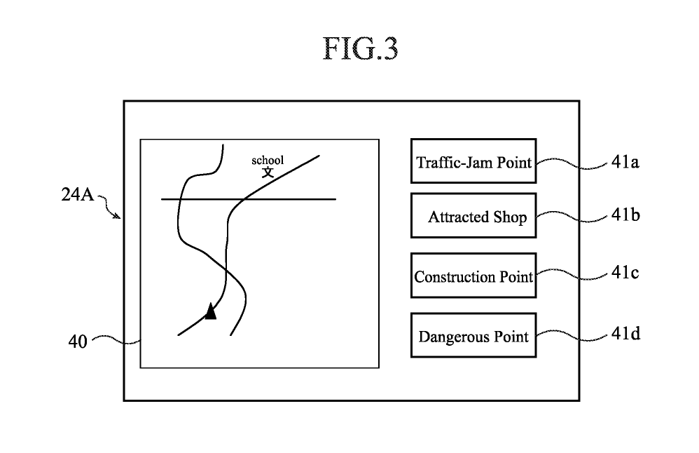

FIG. 3 is a diagram showing an example of the screen for interested subject inputs, and illustrates a case in which the user input unit 20 is a touch panel using the display screen of the output unit 24. In FIG. 3, in addition to a map display section 40, there are provided software buttons 41a to 41d for interested subject inputs.

Various information categories are written on the software buttons 41a to 41d.

For example, if the traffic-jam point button 41a is depressed at the time when a frequently jammed point is passed, an information category of “traffic-jam point” is outputted as the interested subject to the user information detection unit 21. Also, if the attracted shop button 41b is depressed when a new shop unknown to the user is passed, an information category of “attracted shop” (shop of interest) is outputted as the interested subject to the user information detection unit 21. Likewise, if the construction point button 41c is depressed when a point under construction is passed, an information category of “construction point” is outputted as the interested subject to the user information detection unit 21. Further, if the dangerous point button 41d is depressed when a point where an accident frequently occurs is passed, an information category of “dangerous point” is outputted as the interested subject to the user information detection unit 21.

However, the information categories of the software buttons shown in FIG. 3 are merely examples; an information category such that the information category is classified more broadly may be utilized, and it may be contemplated to be set hierarchically from a broad category to a detailed category.

Further, although in the above description, the instance in which the software buttons 41a to 41d for interested subject inputs are displayed on the display screen 24A of the output unit 24 is illustrated, it may be arbitrarily provided as dedicated buttons equipped in a steering wheel.

The interested subject may be inputted by a plurality of input devices in combination.

For example, in a combination of the display screen for interested subject inputs and the speech recognition system, when any one of the software buttons 41a to 41d is depressed, a detailed content of the interested subject is uttered, and thereby a speech recognition result thereof is determined as additional information. Also, at the time when any one of the software buttons 41a to 41d is depressed, a pick-up picture (image) of the outside of the vehicle or a captured image of the user's gesture may be arbitrarily determined as the additional information.

In the input of the interest information by combination of the plurality of input devices, available input devices may be restricted depending on a running condition of the vehicle. For example, in a case where the software buttons 41a to 41d operable on the touch panel and the dedicated buttons equipped in the steering wheel are provided, the touch operation is made invalid during running of the vehicle, and only the dedicated buttons equipped in the wheel are made valid.

From among information inputted in the user terminal device 2 with the use of the user input unit 20, the user information detection unit 21 detects the information inputted through the HMI for interested subject inputs as the interested subject, and generates the interest information by adding thereto at least positional information of the point where the interested subject is inputted (Step ST2). For example, the interest information is constituted by the string of information (attributions) such as <latitude, longitude, . . . : interested subject> as mentioned above.

However, the interest information may be constituted to refer to external information corresponding to the data indicating the interested subject with the use of a file name of the data indicating the interested subject.

For example, when the interested subject represented by image data or audio data is included, the file name of the data is set. Namely, when the interested subject is audio data, and this is stored in a memory region different from that of the interest information, the following interest information is generated: the file name of the audio data is set as <latitude, longitude, . . . : file name>.

Also, the interest information may contain a plurality of interested subjects. For example, when the file name of the data indicating the interested subject is used, the interest information may be constituted by the audio data itself and the file name thereof as the interested subject.

Then, the user information detection unit 21 stores the generated interest information in the device-side interest information storage unit 22 (Step ST3).

When the interest information is stored in the device-side interest information storage unit 22, the communications unit 23 transmissibly connects to the server device 3 via the communications network 4, to thereby transmit thereto a storing request containing a user ID of the user A. However, when the communications unit 23 does not store the information in the device-side interest information storage unit 22, the storing request may be transmitted at the time when the interest information is generated by the user information detection unit 21.

Upon receiving the storing request from the user terminal device 2 by the communications unit 30, the user certification unit 31 in the server device 3 performs certification on the user A as a requestor on the basis of the user ID contained in the request (Step ST4).

Upon certification of the server device 3, the communications unit 23 in the user terminal device 2 transmits the interest information generated at step ST2 to the server device 3 via the communications network 4.

The user certification unit 31 in the server device 3 stores the interest information received from the user terminal device 2 by the communications unit 30 in the server-side interest information storage unit 33 in a manner associated with the user ID of the user A (Step ST5). The above corresponds to the processing for the production and store of the interest information.

2) Browse (Use) of Interest Information

When the user A wishes to browse the interest information related to the passing point during the movement by the vehicle, information serving as the retrieval key for the interest information is inputted through the use of the user input unit 20.

For example, when the user input unit 20 is the touch panel using the display screen of the output unit 24, the software button for point inputs is displayed on the display screen. When the user A passes by a scenic place, for example, and wishes to browse interest information related to this point, the user depresses the button for point inputs. This causes the user input unit 20 to notify the user information detection unit 21 of the depression of the button for point inputs.

When the user information detection unit 21 is notified of the depression of the button for point inputs, that is, the input of the information indicative of the point interested by the user A, the positional information at that time is acquired from the position detection unit 21a to output a retrieval request containing the positional information and the user ID to the communications unit 23. The communications unit 23 transmits the above retrieval request inputted from the user information detection unit 21 to the server device 3 via the communications network 4.

When the retrieval request from the user terminal device 2 is received by the communications unit 30, the user certification unit 31 in the server device 3 certifies the user A of the retrieval requestor on the basis of the user ID contained in the retrieval request. It is noted that when another interest information related to the same point as that of the interest information stored in the serve-side interest information storage unit 33 is retrieved as a series of processes from Step ST5, the above certification process is omitted because the user certification is completed previously at Step ST4.

Subsequently, the user information retrieval unit 32 retrieves the server-side interest information storage unit 33 by using the positional information extracted from the above retrieval request as the key (Step ST6). In this connection, interest information of the point included within the area in the predetermined range that includes the point of the positional information used as the retrieval key as mentioned above is also retrieved and regarded as retrieval requested interest information.

Also, in a case where interest information related to the same point as that of the interest information stored at Step ST5 is retrieved, the above predetermined range to be regarded as the same is set in the positional information, and interest information of the point included within the area in that range is retrieved.

If the retrieval requested interest information exists in the server-side interest information storage unit 33 (Step ST6; YES), the user information retrieval unit 32 reads out the interest information from the server-side interest information storage unit 33, and transmits the resultant to the user terminal device 2 of the requester by the communications unit 30 (Step ST7).

Meanwhile, at step ST7, the user information retrieval unit 32 may operate to record a retrieval requested frequency with respect to the interest information stored in the server-side interest information storage unit 33 or a change of the frequency in a given period of time, and transmit these pieces of information to the user terminal device 2 of the retrieval requester, in addition to the interest information of the retrieval result. In this case, the interest information transmitted to the user terminal device 2 of the retrieval requester is constituted by, for example, <latitude, longitude, frequency, additional information 1, additional information 2, . . . : interested subject>. This makes it possible to grasp the frequency in which the interest information is retrieval requested, namely the degree in which the interest in the point is taken.

If “Store” is set by the user A (Step ST8; YES), the communications unit 23 in the user terminal device 2 stores the interest information of the retrieval result received from the server device 3 in the device-side interest information storage unit 22 (Step ST9).

On the other hand, if “Store” is not set by the user A (Step ST8; NO), or if the interest information of the retrieval result is stored in the device-side interest information storage unit 22 at step ST9, the communications unit 23 sends the interest information of the retrieval result to the output unit 24. The output unit 24 presents the retrieval result of the inputted interest information to the user A (Step ST10).

Additionally, when another interest information related to the same point as that of the interest information stored in the serve-side interest information storage unit 33 is retrieved as a series of processes from Step ST5, interest information stored with respect to the same point is presented in addition to the interest information stored at Step ST5.

As described above, at the passing scenic place during the movement, the user A implements an explicit operation indicating the interested point using the user input unit 20, and thereby interest information related to that point (POI information) is fed back from the server device 3.

If the retrieval requested interest information is absent (Step ST6; NO), the communications unit 30 in the server device 3 transmits information indicating the absence of the interest information to the user terminal device 2 of the requester.

Upon receiving the above information from the server device 3, the communications unit 23 in the user terminal device 2 notifies the output unit 24 of the absence of the retrieval requested interest information. When this notification is received, the output unit 24 presents the absence of the retrieval requested interest information to the user A (Step ST11).

It is noted that the presentation method of the interest information may be provided as follows depending on a running condition of the vehicle:

A) at the time of the stop of the vehicle, to present the interest information generated by that time (for example, interest information stored in the device-side interest information storage unit 22);

B) to present the interest information by sound only without display when the vehicle is running; and

C) when the vehicle reaches the point where the interested subject is inputted previously, to present the interest information related to the point. In this case, it may be past interest information stored in the device-side interest information storage unit 22; further, the retrieval request may be made to the server device 3, and the interest information newly stored with respect to the said point may be presented.

As described above, according to Embodiment 1, there is provided: the user input unit 20 for receiving the input of the subject of interest at the moved point; the position detection unit 21a for detecting the positional information; the user information detection unit 21 for generating interest information that contains the subject of interest inputted in the user input unit 20, and the positional information of the point in which the corresponding subject of interest is inputted and which is detected by the position detection unit 21a; the communications unit 23, transmissibly connected to the server device 3, for storing in the server device 3 the interest information generated by the user information detection unit 21 and for acquiring the interest information retrieved in response to the request from among the interest information stored in the server device 3; and the output unit 24 for outputting the interest information generated by the user information detection unit 21 or the interest information acquired by the communications unit 23 to present the resultant to the user. With such a configuration, the user can stores accurately the interested subject at the passing point during the movement, and use the information of the point appropriately.

In the above Embodiment 1, although the case where the user terminal device 2 and the server device 3 exchanges the information via the communications network 4 such as the Internet is described, the present invention is not limited thereto. For example, the server device 3 may exchange the information between itself and the user terminal device 2 installed in the vehicle by way of a road-side wireless communication device.

Further, in a case where there exist a plurality of vehicles installing the user terminal device 2, when the communications unit 23 has a function of inter-vehicle communication, the information may be exchanged not only between itself and the server device 3, but also between itself and the user terminal device 2 of another vehicle existing within an inter-vehicle communication area.

### Embodiment 2

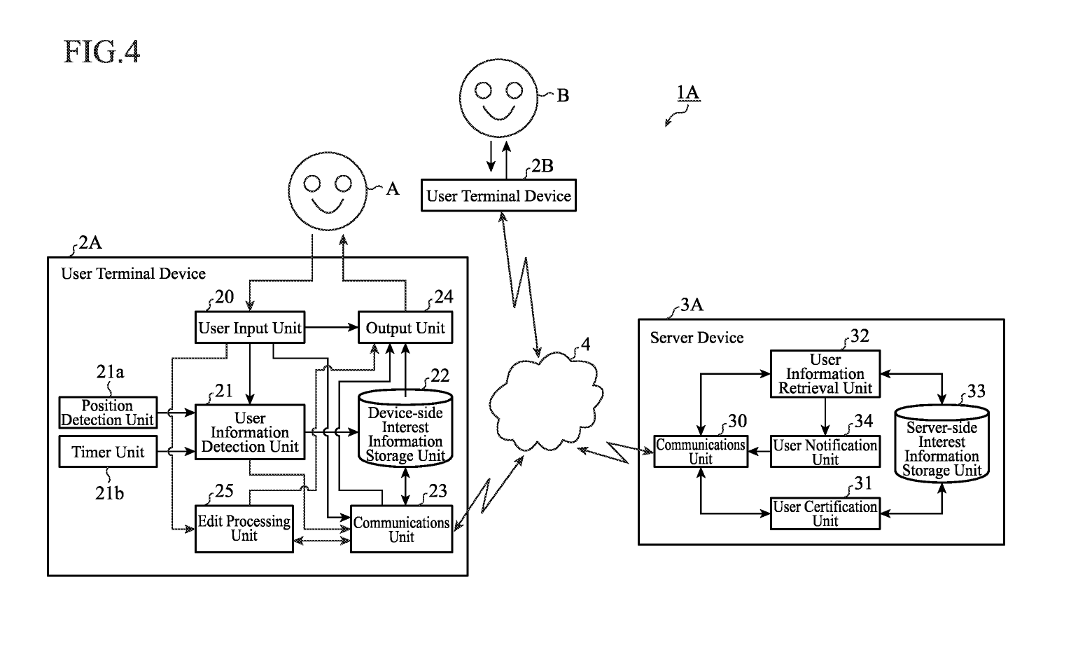

FIG. 4 is a block diagram showing a configuration of an information processing system according to Embodiment 2 of the invention, the same reference numerals are given for the same components as those in FIG. 1, and descriptions thereof will be omitted. In an example shown in FIG. 4, a case is described where a server device 3A is transmissibly connected with each of a user terminal device 2A controlled by a user A and a user terminal device 2B controlled by a user B in an information processing system 1A of Embodiment 2. It is noted that interest information stored in the server device 3A is browsable from both of the user terminal devices 2A and 2B.

The user terminal device 2A includes an edit processing unit 25 in addition to the components shown in the above Embodiment 1. The edit processing unit 25 is a component for editing the interest information containing an interested subject and additional information thereof based on the information inputted by the user input unit 20.

Hereinafter, a case is described where the interest information stored in the server device 3A by the user B is edited through the use of the user terminal device 2A controlled by the user A. Thus, the user terminal device 2B may have the edit processing unit 25 like the user terminal device 2A, or may has a configuration like the above Embodiment 1.

Further, the server device 3A includes a user notification unit 34 in addition to the components shown in the above Embodiment 1. The user notification unit 34 is a component for executing notification processing to the user terminal devices 2A,2B by the communications unit 30; in particular, in a case where the user who edited the interest information is different from the user who generated the said interest information and stored the resultant in a sever-side interest information storage unit 33, the unit makes an edit notification indicative of a matter that the corresponding interest information was edited to the user who generated and stored the edited interest information.

Next, an operation thereof will be described.

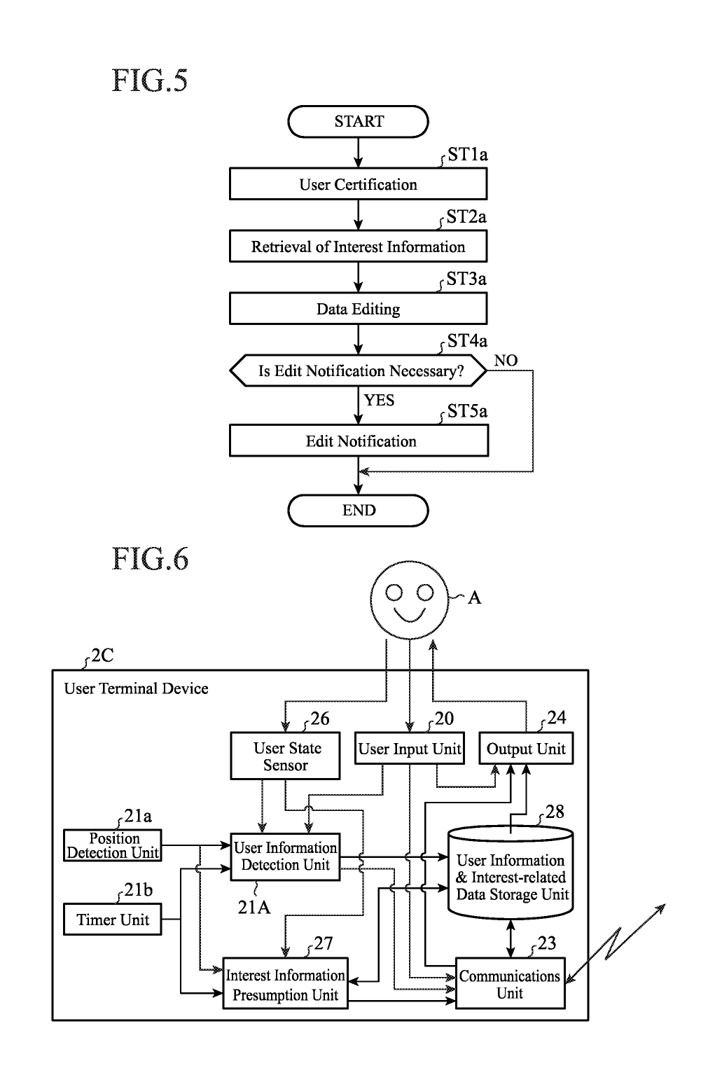

FIG. 5 is a flowchart showing a flow of edit processing by the information processing system according to Embodiment 2, and the details of the processing will be described with reference to FIG. 5.

The user A instructs a login into the server device 3A by the user input unit 20. When the login is instructed by the user input unit 20, a communications unit 23 transmits a login request containing a user ID of the user A to the server device 3A via a communications network 4.

When receiving the login request from the user terminal device 2A by the communications unit 30, the user certification unit 31 in the server device 3A certifies the user A of the requester based on the user ID contained in the login request (Step ST1a).

Upon certification by the user certification unit 31, the user A activates the edit processing unit 25 by the user input unit 20. The edit processing unit 25 provides an HMI for information edits by the user input unit 20 and an output unit 24. For example, when the user input unit 20 is a touch panel using a display screen of the output unit 24, an screen for information edits is displayed on the display screen.

Through a touch operation onto the screen for information edits, the user A instructs to retrieve interest information of a subject to be edited from among the interest information stored in the server device 3A.

For example, the following are used as a retrieval key: the interested subject; a time when the interested subject was inputted; a name of the user who inputted the interested subject; a position of the point where the interested subject was inputted, and the like, each being information constituting the interest information. A retrieval request containing the retrieval key is transmitted to the server device 3A by the communications unit 23.

The user information retrieval unit 32 in the server device 3A retrieves the server-side interest information storage unit 33, based on the above retrieval key contained in the retrieval request received by the communications unit 30 (Step ST2a). It is noted that since the interest information is constituted by a string of information (attributions), such as <latitude, longitude, frequency, additional information-1, additional information-2, . . . : interested subject>, it can be handled as data in a form of RDB (Relational Data Base). Hereupon, the user information retrieval unit 32 may be configured to perform retrieval with an SQL (Structured Query Language) sentence or the like. Information of the retrieval result by the user information retrieval unit 32 is transmitted by the communications unit 30 to the user terminal device 2A.

The communications unit 23 in the user terminal device 2A displays the interest information of the retrieval result received from the server device 3A in the above screen for information edits.

Then, the edit processing unit 25 performs data editing of the interest information of the above retrieval result with the use of the information for edits inputted in the user input unit 20 (Step ST3a).

For example, in a case where an edit to add the inputted information for edits to the interest information is carried out, since the interest information of the above retrieval result is constituted as <user name, information-1, information-2, . . . , information-N: interested subject>, the inputted information is added in a form following this string. That is, the data of the interest information after editing has a configuration of <user name, information-1, information-2, . . . , information-N, information-N+1: interested subject>.

Meanwhile, when an id given for each interest information is set in the data configuration of the interest information, it is possible to perform the data editing using the id as a reference(ref). For example, if interest information provided with the id is constituted as <id, user name, information-1, information-2, . . . , information-N: interested subject>, and information to be added thereto is constituted as <id, user name, ref, information-N+1, . . . : interested subject>, the information-N+1 and following information can be added thereto with reference to the id.

The thus edited interest information is transmitted to the server device 3A by the communications unit 23.

The user information retrieval unit 32 in the server device 3A stores the interest information after editing received by the communications unit 30 in the server-side interest information storage unit 33 in a manner associated with a user ID (user B).

Then, the user notification unit 34 compares the user ID obtained at the time of the login request from the user terminal device 2A with the user ID associated with the above interest information after editing, and then determines whether the edit notification is necessary or not (Step ST4a). In this Step, if both the user IDs are identical to each other, so that it is judged that the user A edited its own interest information, the edit notification is determined unnecessary (Step ST4a; NO) to thereby end the processing.

In contrast, if both the user IDs are different from each other, so that it is judged that the edit was made by a user other than the user who originally stored the corresponding interest information, the edit notification is determined necessary (Step ST4a; YES) and the user notification unit 34 identifies the user terminal device corresponding to the user ID based on the user ID associated with the interest information after editing. Here, since the user A edited the interest information of the user B, the user terminal device 2B is identified from the user ID associated with the interest information after editing.

Thereafter, the user notification unit 34 makes the edit notification to the user terminal device 2B via the communications unit 30 (Step ST5a). It is noted that the edit notification can be achieved through, for example, an e-mail, an instant messenger, an SNS (Social Network Service), and the like.

Further, although the contents of the edit notification may simply be what the interest information was edited, it doesn't matter the user name who edited, a digest of the edited contents, and the like are notified.

Furthermore, it may be contemplated that the user notification unit 34 makes the edit notification when new information is added to the interest information before and after editing.

Here, a specific example for use in the system will be described, assuming that there is a new shop at a point where the user B passes by during a movement, and a position of the point and an information category (New Shop) were inputted to the user terminal device 2B by an input operation through the HMI for interested subject inputs and then stored as the interest information in the server device 3A.

The above interest information can be edited by the user B in a similar manner to the above by the edit processing unit 25 in the user terminal device 2B. For example, let's assume that the user B made an edit later to add thereto commentary information of “What is the reputation of the shop?” as additional information.

Since the interest information stored in the server device 3A is browsable by any registered user, the comment of “What is the reputation of the shop?” can be viewed between the registered users.

In this situation, when the user A of the registered user actually visits the above shop and states an impression of the shop in response to the above comment, the user A performs an edit to add commentary information or the like to the above interest information of the user B by the edit processing unit 25 in the user terminal device 2A.

For example, when the comment of “It was not so delicious” is added thereto, the user notification unit 34 in the server device 3A makes the edit notification to the user B.

When the user B browses its own interest information in response to the edit notification by the user terminal device 2B, the user can view the comment of “It was not so delicious” by the user A as the reputation concerning the new shop.

As described above, according to Embodiment 2, there is provided with the edit processing unit 25 for editing the interest information stored in the server device 3A, and hence even if only the interested subject at the point where the user passes by during the movement and the positional information of the point are stored as the interest information in the server device 3A, it is possible to edit the interest information later, so that useful interest information can be shared between the plurality of users.

Incidentally, in the above Embodiment 2, although the case where the edit processing unit is provided in the user terminal device is described, the edit processing unit may be provided on the server device side. In this instance, the edit processing unit in the server device receives the edit request and information for edits from the user at the communications unit 30 via the communications network 4, and performs the edit processing according to these request and information. Further, the user notification unit 34 determines the identity of the users for the interest information edited by the edit processing unit, and makes the edit notification according to the determination result.

### Embodiment 3

FIG. 6 is a block diagram showing a configuration of a user terminal device according to Embodiment 3 of the invention, the same reference numerals are given for the same components as those in FIG. 1, and descriptions thereof will be omitted. In FIG. 6, a user terminal device 2C of Embodiment 3 includes a user input unit 20, a user information detection unit 21A, a position detection unit 21a, a timer unit 21b, communications unit 23, an output unit 24, a user state sensor 26, an interest information presumption unit 27, and a user information & interest-related data storage unit 28.

The user information detection unit 21A is a component for detecting an interested subject inputted through an explicit operation of the user A using the user input unit 20 from among information inputted in the user terminal device 2C through the use of the user input unit 20, and for generating user state & interest-related data that combines interest information containing the interested subject and the positional information at the point where the interested subject is inputted with information indicating the state of the user A at the time when the interested subject is inputted. It is noted that a detection method of the interested subject detects information inputted through an HMI for interested subject inputs as the interested subject, similarly to the above Embodiment 1. For example, the information is distinguished from another information such that a specific extension is set to the interested subject through the HMI for interested subject inputs.

The user state sensor 26 is a sensor for detecting information indicating the state of the user A, and detects, as information indicating the user state, biological information indicating a physical state of the user A such as heart rate, and/or information indicating a vehicle driving condition on which a mental state of the user A is reflected, such as a shift amount of eyes and a vehicle speed change.

For example, the heart rate for a given time (usually, 1 minute) from the time when the interested subject is inputted, is detected through the use of a sensor for detecting pulses. Also, the shift amount of eyes in a given time from the time when the interested subject is inputted is detected in such a manner that a position of the eyes is image recognized from images in which the user A is captured through the use of a camera for capturing the user A. Further, the vehicle speed change in a given period from the time when the interested subject is inputted is detected based on vehicle information acquired from a vehicle control device.

It is noted that the information indicating the user state is not limited to the heart rate, the shift amount of eyes, and/or the vehicle speed change in the above, and may be any information that can specify the user state at the time when the user inputs the interested subject.

The interest information presumption unit 27 is a component for determining a trend of the user state at the time when the user A inputs the interested subject by using past user state & interest-related data that is stored in the user information & interest-related data storage unit 28, and for presuming the interested subject of the user A based on the range of the data of the user state representing the trend. For example, if information serially inputted from the user state sensor 26 and indicating the user state of the user A falls within the range representing the trend of the user state at the time when the interested subject of the user A determined previously is inputted, the corresponding interested subject is presumed as the interested subject of the user A at that time.

The user information & interest-related data storage unit 28 is a storage for storing the user information & interest-related data, and stores the user information & interest-related data generated by the user information detection unit 21A and/or the user information & interest-related data generated by the interest information presumption unit 27.

It is noted that in the server device 3 of Embodiment 3, the interest information is stored as the user information & interest-related data in the server-side interest information storage unit 33. Accordingly, the operation of the sever device 3 in Embodiment 3 can be described when the “interest information” is replaced with the “user information & interest-related data” in the description of the above Embodiment 1.

Next, an operation thereof will be described.

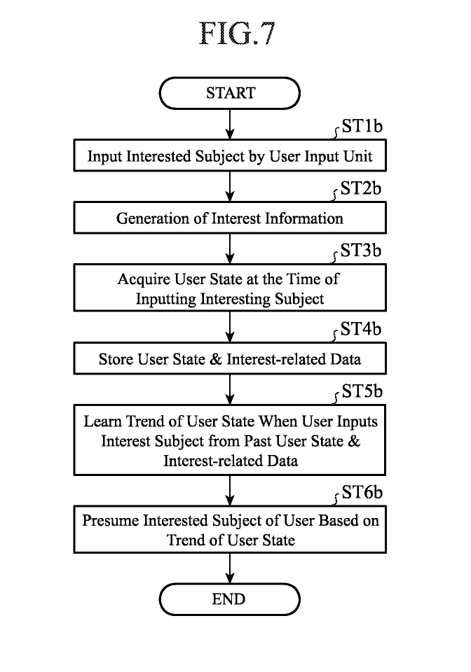

FIG. 7 is a flowchart showing a flow of processing by the user terminal device of Embodiment 3, and details of the processing are described with reference to FIG. 7. It is noted that the processing by the user terminal device 2C of Embodiment 3 is divided into: a process for generating and storing user information & interest-related data including a combination of interest information containing the interested subject inputted through an explicit operation performed by the user, and the user state at the time of the input; and a process for presuming the interested subject of the user A from the trend that is determined from the past user information & interest-related data.

1) Generation and Store of User Information & Interest-Related Data

A subject interested by the user A (interested subject) at a passing point during a movement is inputted by the user input unit 20 (Step ST1b). It is noted that an input method of the interested subject is similar to that of the above Embodiment 1.

Then, from among information inputted in the user terminal device 2C, the user information detection unit 21A detects the information inputted through the HMI for interested subject inputs, as the interested subject by the user input unit 20, and generates the interest information by adding thereto at least positional information of the point where the said interested subject is inputted (Step ST2b). For example, the interest information is constituted by a string of information (attributions), such as <latitude, longitude, . . . : interested subject>.

Subsequently, the user information detection unit 21A acquires from the user state sensor 26 the user state detected at the time when the interested subject is inputted at step ST1b (Step ST3b), generates user information & interest-related data that combines the user state with the interest information generated at step ST2b, and stores the resultant in the user information & interest-related data storage unit 28 (Step ST4b).

The user information & interest-related data is constituted by the interest information, a string of information indicating the user state, and reference information to the above interest information. For example, the user information & interest-related data is constituted by the interest information represented by <id number, latitude, longitude, . . . : attracted shop>, and information including a string of a reference to the interest information, and information indicating a user state <ref (id number), shift amount of eyes (20 cm/second), vehicle speed change (−10 km/second) >.

2) Presumption of Interested Subject

Next, the interest information presumption unit 27 learns the trend of the user state at the time when the user A inputs the interested subject by using the past user state & interest-related data that is stored in the user information & interest-related data storage unit 28 (Step ST5b). It is noted that a programming technique for reinforcement learning, functional logic, or the like is applied as an algorithm for learning the trend of the user state.

For example, from the user state & interest-related data having an information category of “Attracted Shop” as the interested subject, the trend of the user state at the time when the information category of “Attracted Shop” is inputted is learned, so that the data range of the user state representing the trend is determined. Specifically, the data range of the user state is determined, such that the shift amount of eyes is 15 cm/second or more, and that the vehicle speed change is ±7 km/second.

Then, if the information serially inputted from the user state sensor 26 and indicating the user state of the user A falls within the range representing the trend of the user state determined at step ST5b, the interest information presumption unit 27 presumes that the interested subject representing the trend is the interested subject of the user A at the present time (Step ST6b). For example, if the present user state is given by the shift amount of eyes of 20 cm/second and the vehicle speed change of ±7 km/second, it falls within the range representing the trend of the user state determined at step ST5b, and thereby the interested subject of the user A at the present time is presumed as “Attracted Shop”.

Thereafter, the interest information presumption unit 27 may generate interest information containing at least the interested subject presumed at step ST6b and the positional information of the point at that time, similarly to the user information detection unit 21A, and further generate user state & interest-related data that combines this interest information with information indicating a state of the user A at that time, to thereby store the resultant in the user information & interest-related data storage unit 28. In this instance, the output unit 24 presents the user information & interest-related data containing the interest information presumed by the interest information presumption unit 27 to the user A, and provides the HMI that makes the user A accept whether the data should be stored or not, so that only the user information & interest-related data accepted by the user A is stored. The unaccepted user information & interest-related data is not stored, and the range representing the trend of the user state used for the corresponding presumption is abandoned to start newly the learning, or the range is corrected and narrowed so as to be presumed more severely. This makes it possible to enhance presumption accuracy of the interested subject.

Further, at step ST6b, the interest information presumption unit 27 may make a retrieval request to the server device 3 with the presumed interest information and the positional information of the point at that time as a retrieval key by way of the communications unit 23. The output unit 24 presents to the user A the user information & interest-related data of the retrieval result transmitted from the server device 3. At this time, in the passing point during the movement by the vehicle or the like, the user A is automatically presented with the interest information containing the interested subject that is presumed according to the user' own state at that time.

As described above, according to Embodiment 3, there is provided with: the user state sensor 26 for detecting the user state; the user information & interest-related data storage unit 28 for storing the data combining the interest information generated by the user information detection unit 21A with the user state detected by the user state sensor 26 at the time when the subject of interest contained in the said information is inputted; and the user state presumption unit 27 for learning the trend of the user state at the time when the subject of interest is inputted from the data stored in the user information & interest-related data storage unit 28, and for presuming the subject of interest from the user state detected by the user state sensor 26 on the basis of the trend of the user state thus learned. With such a configuration, it is possible to presume automatically the subject of interest of the user A from the information indicating the user state detected by the user state sensor 26.

Meanwhile, the information processing device according to the present invention may be applied not only to an on-board navigation device, but also to a display device of a mobile-phone terminal or a handheld terminal (PDA; Personal Digital Assistance). Also, it may be applied to a display device such as a PND (Portable Navigation Device) that is used with carried and brought by a person in an moving object of a vehicle, a train, a ship, an airplane, or the like.

It is noted that according to the present invention, within the scope of the invention, the embodiments can be freely combined, or any components in the embodiments can be modified or any components in the embodiments can be omitted.

### INDUSTRIAL APPLICABILITY

Since the information processing device according to the invention can accurately store the subject interested by the user at the passing point during the movement and appropriately use the information at the point, it is suitable for a navigation device that acquires the information along a driving path.

### EXPLANATION OF REFERENCE NUMERALS

1, 1A: information processing system, 2, 2A, 2B, 2C: user terminal device, 3, 3A: server device, 4: communications network, 20: user input unit, 21: user information detection unit, 22: device-side interest information storage unit, 23, 30: communications unit, 24: output unit, 25: edit processing unit, 26: user state sensor, 27: interest information presumption unit, 28: user information & interest-related data storage unit, 31: user certification unit, 32: user information retrieval unit, 33: server-side interest information storage unit, 34: user notification unit.

1-7. (canceled)

8. An information processing device to be installed in or carried by a moving object, comprising:
a user input unit for receiving an input of a subject of interest at a point in which the moving object is moved;
a position detection unit for detecting positional information of the moving object;
an interest information generation unit for generating interest information that contains the subject of interest inputted in the user input unit, and the positional information of the point in which the corresponding subject of interest is inputted, and which is detected by the position detection unit;
a communication unit, transmissibly connected to an external device, for storing in the external device the interest information generated by the interest information generation unit and for acquiring the interest information retrieved in response to a request from among the interest information stored in the external device;
an output unit for outputting the interest information generated by the interest information generation unit or the interest information acquired by the communication unit to present the resultant to a user; and
an edit processing unit for editing the interest information stored in the external device.

9. The information processing device of claim 8, wherein the user input unit receives an input of at least one of an information category of the subject, a captured image of the subject and voice information indicating content of the subject as the interested subject.

10. The information processing device of claim 8, wherein the communication unit makes a retrieval request for the interest information using the positional information as a key to the external device.

11. The information processing device of claim 8, further comprising:
a user state detection unit for detecting a state of the user;
a storage unit for storing data combining the interest information generated by the interest information generation unit with the state of the user detected by the user state detection unit at the time the subject of interest contained in the interest information is inputted; and
a presumption unit for learning from the data stored in the storage unit a trend of the user state at the time the subject of interest is inputted, and for presuming the subject of interest from the state of the user detected by the user state detection unit on the basis of the trend of the learned user state.

12. An information processing system that includes an information retrieval server, and an information processing device transmissibly connected thereto, said information processing device being installed in or carried by a moving object, and comprising:
a user input unit for receiving an input of a subject of interest at a moved point of the moving object;
a position detection unit for detecting positional information of the moving object;
an interest information generation unit for generating interest information that contains the subject of interest inputted in the user input unit, and the positional information of the point in which the subject of interest subject is inputted, and which is detected by the position detection unit;
a communication unit for storing in the information retrieval server the interest information generated by the interest information generation unit and for acquiring from among the interest information stored in the information retrieval server the interest information retrieved in response to a request; and
an output unit for outputting the interest information generated by the interest information generation unit or the interest information acquired by the communication unit to present the resultant to a user,
wherein the information retrieval server comprises a user notification unit that, in a case where a user who controls the information processing device that stores the interest information in the information retrieval server and a user who edited the corresponding interest information are different from each other, notifies the user who stored the corresponding interest information in the information retrieval server of what an edit was made.
